(19) United States
(12) Patent Application Publication
(10) Pub. No.: US 2002/0196744 A1
(43) Pub. Date: Dec. 26, 2002

(54) Path discovery and mapping in a storage area network

(76) Inventor: Michael A. O'Connor, San Jose, CA (US)

Correspondence Address: Rory D. Rankin, Conley, Rose & Tayon, P.C., P.O. Box 398, Austin, TX, 78767, US

(21) Appl. No.: 09/892,330

(22) Filed: Jun. 26, 2001

(51) Int. Cl. H04L 12/28

(52) U.S. Cl. 370/254; 370/216

(57) ABSTRACT

A method and mechanism for allocating storage in a computer network. A storage allocation mechanism is configured to automatically identify and discover paths to storage which are coupled to a computer network. The identified storage is then selected for allocation to a host coupled to the computer network. A database describing the selected storage and paths to the selected storage is created and stored within the host. Upon detecting a failure of the host, the allocation mechanism is configured to automatically retrieve the stored database and re-map the previously mapped storage to the host. In addition, the allocation mechanism may check the validity of the database subsequent to its retrieval. Further, the allocation mechanism may attempt to access the storage corresponding to the database. In response to detecting the database is invalid, or the storage is inaccessible, the allocation mechanism may convey a message indicating a problem has been detected.

### BACKGROUND OF THE INVENTION

1. Field of the Invention

This invention is related to the field of computer networks and, more particularly, to the allocation of storage in computer networks.

2. Description of the Related Art

While individual computers enable users to accomplish computational tasks which would otherwise be impossible by the user alone, the capabilities of an individual computer can be multiplied by using it in conjunction with one or more other computers. Individual computers are therefore commonly coupled together to form a computer network. Computer networks may be interconnected according to various topologies. For example, several computers may each be connected to a single bus, they may be connected to adjacent computers to form a ring, or they may be connected to a central hub to form a star configuration. These networks may themselves serve as nodes in a larger network. While the individual computers in the network are no more powerful than they were when they stood alone, they can share the capabilities of the computers with which they are connected. The individual computers therefore have access to more information and more resources than standalone systems. Computer networks can therefore be a very powerful tool for business, research or other applications.

In recent years, computer applications have become increasingly data intensive. Consequently, the demand placed on networks due to the increasing amounts of data being transferred has increased dramatically. In order to better manage the needs of these data-centric networks, a variety of forms of computer networks have been developed. One form of computer network is a “Storage Area Network”. Storage Area Networks (SAN) connect more than one storage device to one or more servers, using a high speed interconnect, such as Fibre Channel. Unlike a Local Area Network (LAN), the bulk of storage is moved off of the server and onto independent storage devices which are connected to the high speed network. Servers access these storage devices through this high speed network.

One of the advantages of a SAN is the elimination of the bottleneck that may occur at a server which manages storage access for a number of clients. By allowing shared access to storage, a SAN may provide for lower data access latencies and improved performance. When storage on a SAN is mapped to a host, an initialization procedure is typically run to configure the paths of communication between the storage and the host. However, if the host requires rebooting or otherwise has its memory corrupted, knowledge of the previously mapped storage and corresponding paths may be lost. Consequently, it may be necessary to again perform the initialization procedures to configure the communication paths and re-map the storage to the host.

What is desired is a method of automatically discovering communication paths and mapping storage to hosts.

### SUMMARY OF THE INVENTION

Broadly speaking, a method and mechanism for allocating storage in a computer network are contemplated. In one embodiment, a host coupled to a storage area network includes a storage allocation mechanism configured to automatically discover and identify storage devices in the storage area network. In addition, the mechanism is configured to discover paths from the host to the storage which has been identified. Subsequent to identifying storage devices in the storage area network, one or more of the devices may then be selected for mapping to the host. A database describing the selected storage devices and paths is created and stored within the host. Upon detecting a failure of the host has occurred, the allocation mechanism is configured to automatically retrieve the stored database and perform a corresponding validity check. In one embodiment, the validity check includes determining whether the database has been corrupted and/or attempting to access the storage devices indicated by the database. In response to determining the validity of the database, the storage devices indicated by the database are re-mapped to the host. However, in response to detecting the database is invalid, or the storage is inaccessible, the allocation mechanism may convey a message indicating a problem has been detected.

### BRIEF DESCRIPTION OF THE DRAWINGS

Other objects and advantages of the invention will become apparent upon reading the following detailed description and upon reference to the accompanying drawings in which:

FIG. 1 is an illustration of a local area network.

FIG. 2 is an illustration of a storage area network.

FIG. 3 is an illustration of a computer network including a storage area network in which the invention may be embodied.

FIG. 4 is a block diagram of a storage area network.

FIG. 4A is a flowchart showing one embodiment of a method for allocating storage.

FIG. 5 is a block diagram of a storage area network.

FIG. 6 is a flowchart showing one embodiment of a re-allocation method.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### Overview of Storage Area Networks

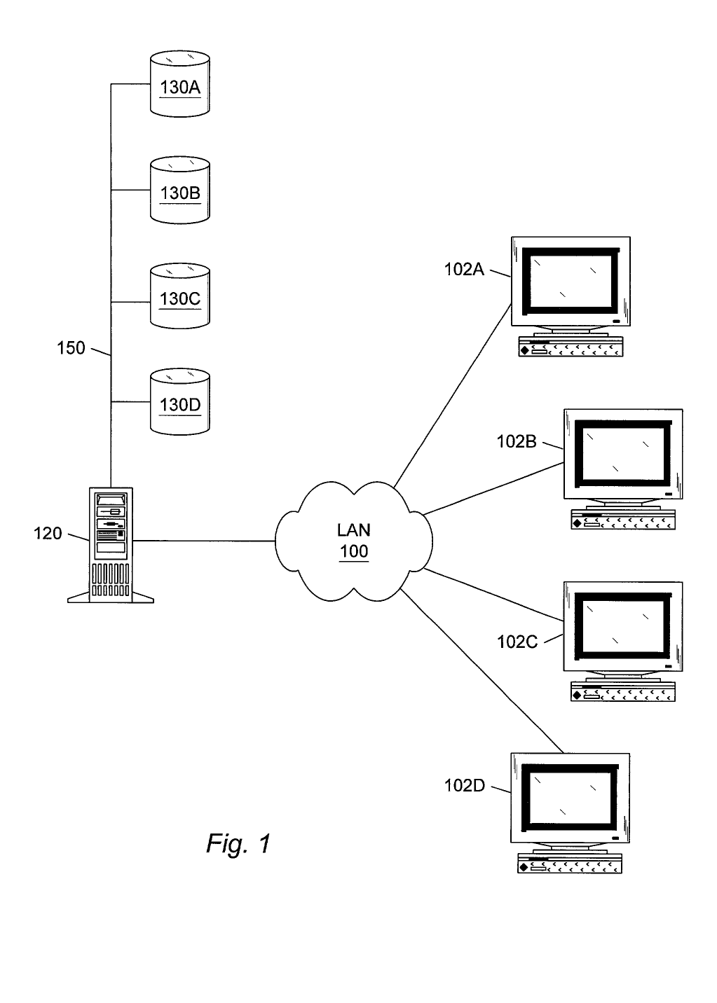

Computer networks have been widely used for many years now and assume a variety of forms. One such form of network, the Local Area Network (LAN), is shown in FIG. 1. Included in FIG. 1 are workstation nodes 102A-102D, LAN interconnection 100, server 120, and data storage 130. LAN interconnection 100 may be any number of well known network topologies, such as Ethernet, ring, or star. Workstations 102 and server 120 are coupled to LAN interconnect. Data storage 130 is coupled to server 120 via data bus 150.

The network shown in FIG. 1 is known as a client-server model of network. Clients are devices connected to the network which share services or other resources. These services or resources are administered by a server. A server is a computer or software program which provides services to clients. Services which may be administered by a server include access to data storage, applications, or printer sharing. In FIG. 1, workstations 102 are clients of server 120 and share access to data storage 130 which is administered by server 120. When one of workstations 102 requires access to data storage 130, the workstation 102 submits a request to server 120 via LAN interconnect 100. Server 120 services requests for access from workstations 102 to data storage 130. Because server 120 services all requests for access to storage 130, requests are handled one at a time. One possible interconnect technology between server and storage is the traditional SCSI interface. A typical SCSI implementation may include a 40 MB/sec bandwidth, up to 15 drives per bus, connection distances of 25 meters and a storage capacity of 136 gigabytes.

As networks such as shown in FIG. 1 grow, new clients may be added, more storage may be added and servicing demands may increase. As mentioned above, all requests for access to storage 130 will be serviced by server 120. Consequently, the workload on server 120 may increase dramatically and performance may decline. To help reduce the bandwidth limitations of the traditional client server model, Storage Area Networks (SAN) have become increasingly popular in recent years. Storage Area Networks interconnect servers and storage at high speeds. By combining existing networking models, such as LANs, with Storage Area Networks, performance of the overall computer network may be improved.

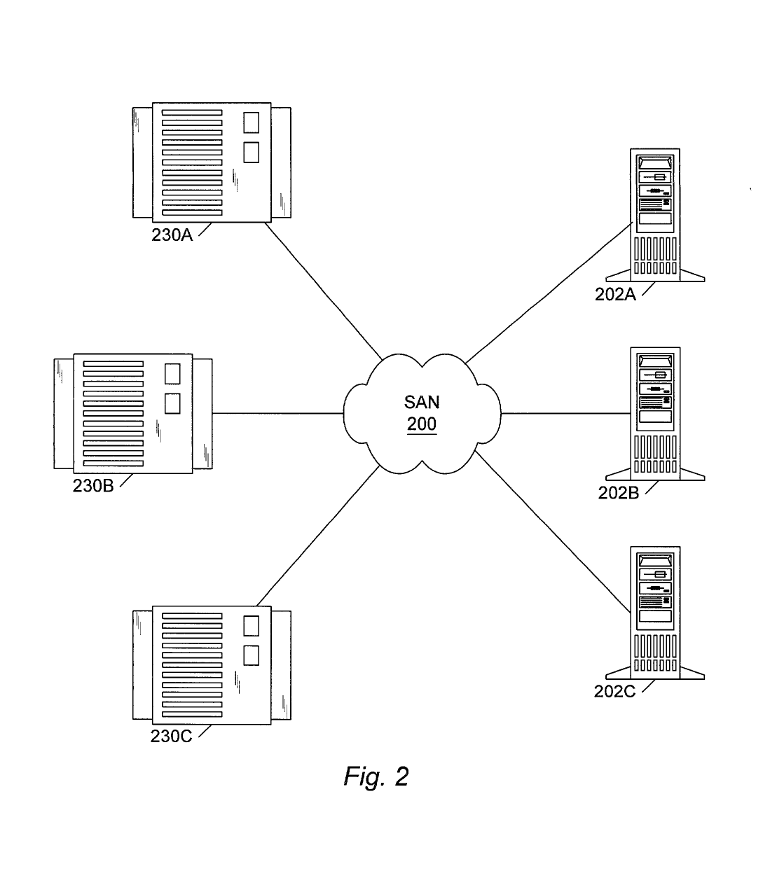

FIG. 2 shows one embodiment of a SAN. Included in FIG. 2 are servers 202, data storage devices 230, and SAN interconnect 200. Each server 202 and each storage device 230 is coupled to SAN interconnect 200. Servers 202 have direct access to any of the storage devices 230 connected to the SAN interconnect. SAN interconnect 200 can be a high speed interconnect, such as Fibre Channel or small computer systems interface (SCSI). As FIG. 2 shows, the servers 202 and storage devices 230 comprise a network in and of themselves. In the SAN of FIG. 2, no server is dedicated to a particular storage device as in a LAN. Any server 202 may access any storage device 230 on the storage area network in FIG. 2. Typical characteristics of a SAN may include a 200 MB/sec bandwidth, up to 126 nodes per loop, a connection distance of 10 kilometers, and a storage capacity of 9172 gigabytes. Consequently, the performance, flexibility, and scalability of a Fibre Channel based SAN may be significantly greater than that of a typical SCSI based system.

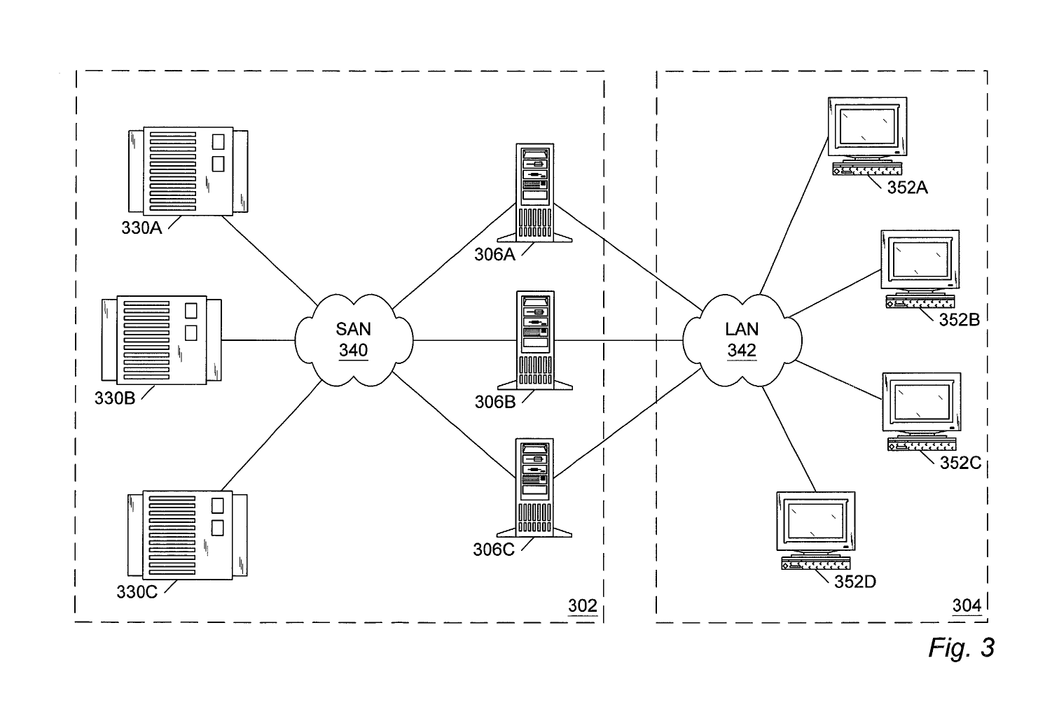

FIG. 3 shows one embodiment of a SAN and LAN in a computer network. Included are SAN 302 and LAN 304. SAN 302 includes servers 306, data storage devices 330, and SAN interconnect 340. LAN 304 includes workstation 352 and LAN interconnect 342. In the embodiment shown, LAN 342 is coupled to SAN 340 via servers 306. Because each storage device 330 may be independently and directly accessed by any server 306, overall data throughput between LAN 304 and SAN 302 may be much greater than that of the traditional client-server LAN. For example, if workstations 352A and 352C both submit access requests to storage 330, two of servers 306 may service these requests concurrently. By incorporating a SAN into the computer network, multiple servers 306 may share multiple storage devices and simultaneously service multiple client 352 requests and performance may be improved.

### File Systems Overview

Different operating systems may utilize different file systems. For example the UNIX operating system uses a different file system than the Microsoft WINDOWS NT operating system. (UNIX is a trademark of UNIX System Laboratories, Inc. of Delaware and WINDOWS NT is a registered trademark of Microsoft Corporation of Redmond, Wash.). In general, a file system is a collection of files and tables with information about those files. Data files stored on disks assume a particular format depending on the system being used. However, disks typically are composed of a number of platters with tracks of data which are further subdivided into sectors. Generally, a particular track on all such platters is called a cylinder. Further, each platter includes a head for reading data from and writing data to the platter.

In order to locate a particular block of data on a disk, the disk I/O controller must have the drive ID, cylinder number, read/write head number and sector number. Each disk typically contains a directory or table of contents which includes information about the files stored on that disk. This directory includes information such as the list of filenames and their starting location on the disk. As an example, in the UNIX file system, every file has an associated unique “inode” which indexes into an inode table. A directory entry for a filename will include this inode index into the inode table where information about the file may be stored. The inode encapsulates all the information about one file or device (except for its name, typically). Information which is stored may include file size, dates of modification, ownership, protection bits and location of disk blocks.

In other types of file systems which do not use inodes, file information may be stored directly in the directory entry. For example, if a directory contained three files, the directory itself would contain all of the above information for each of the three files. On the other hand, in an inode system, the directory only contains the names and inode numbers of the three files. To discover the size of the first file in an inode based system, you would have to look in the file's inode which could be found from the inode number stored in the directory.

Because computer networks have become such an integral part of today's business environment and society, reducing downtime is of paramount importance. When a file system or a node crashes or is otherwise unavailable, countless numbers of people and systems may be impacted. Consequently, seeking ways to minimize this impact is highly desirable. For illustrative purposes, recovery in a clustered and log structured file system (LSF) will be discussed. However, other file systems are contemplated as well.

File system interruptions may occur due to power failures, user errors, or a host of other reasons. When this occurs, the integrity of the data stored on disks may be compromised. In a classic clustered file system, such as the Berkeley Fast File System (FFS), there is typically what is called a “super-block”. The super-block is used to store information about the file system. This data, commonly referred to as meta-data, frequently includes information such as the size of the file-system, number of free blocks, next free block in the free block list, size of the inode list, number of free inodes, and the next free inode in the free inode list. Because corruption of the super-block may render the file system completely unusable, it may be copied into multiple locations to provide for enhanced security. Further, because the super-block is affected by every change to the file system, it is generally cached in memory to enhance performance and only periodically written to disk. However, if a power failure or other file system interruption occurs before the super-block can be written to disk, data may be lost and the meta-data may be left in an inconsistent state.

Ordinarily, after an interruption has occurred, the integrity of the file system and its meta-data structures are checked with the File System Check (FSCK) utility. FSCK walks through the file system verifying the integrity of all the links, blocks, and other structures. Generally, when a file system is mounted with write access, an indicator may be set to “not clean”. If the file system is unmounted or remounted with read-only access, its indicator is reset to “clean”. By using these indicators, the fsck utility may know which file systems should be checked. Those file systems which were mounted with write access must be checked. The fsck check typically runs in five passes. For example, in the ufs file system, the following five checks are done in sequence: (1) check blocks and sizes, (2) check pathnames, (3) check connectivity, (4) check reference counts, and (5) check cylinder groups. If all goes well, any problems found with the file system can be corrected.

While the above described integrity check is thorough, it can take a very long time. In some cases, running fsck may take hours to complete. This is particularly true with an update-in-place file system like FFS. Because an update-in-place file system makes all modifications to blocks which are in fixed locations, and the file system meta-data may be corrupt, there is no easy way of determining which blocks were most recently modified and should be checked. Consequently, the entire file system must be verified. One technique which is used in such systems to alleviate this problem, is to use what is called “journaling”. In a journaling file system, planned modifications of meta-data are first recorded in a separate “intent” log file which may then be stored in a separate location. Journaling involves logging only the meta-data, unlike the log structured file system which is discussed below. If a system interruption occurs, and since the previous checkpoint is known to be reliable, it is only necessary to consult the journal log to determine what modifications were left incomplete or corrupted. A checkpoint is a periodic save of the system state which may be returned to in case of system failure. With journaling, the intent log effectively allows the modifications to be “replayed”. In this manner, recovery from an interruption may be much faster than in the non-journaling system.

Recovery in an LSF is typically much faster than in the classic file system described above. Because the LSF is structured as a continuous log, recovery typically involves checking only the most recent log entries. LSF recovery is similar to the journaling system. The difference between the journaling system and an LSF is that the journaling system logs only meta-data and an LSF logs both data and meta-data as described above.

### Storage Allocation

Being able to effectively allocate storage in a SAN in a manner that provides for adequate data protection and recoverability is of particular importance. Because multiple hosts may have access to a particular storage array in a SAN, prevention of unauthorized and/or untimely data access is desirable. Zoning is an example of one technique that is used to accomplish this goal. Zoning allows resources to be partitioned and managed in a controlled manner. In the embodiment described herein, a method of path discovery and mapping hosts to storage is described.

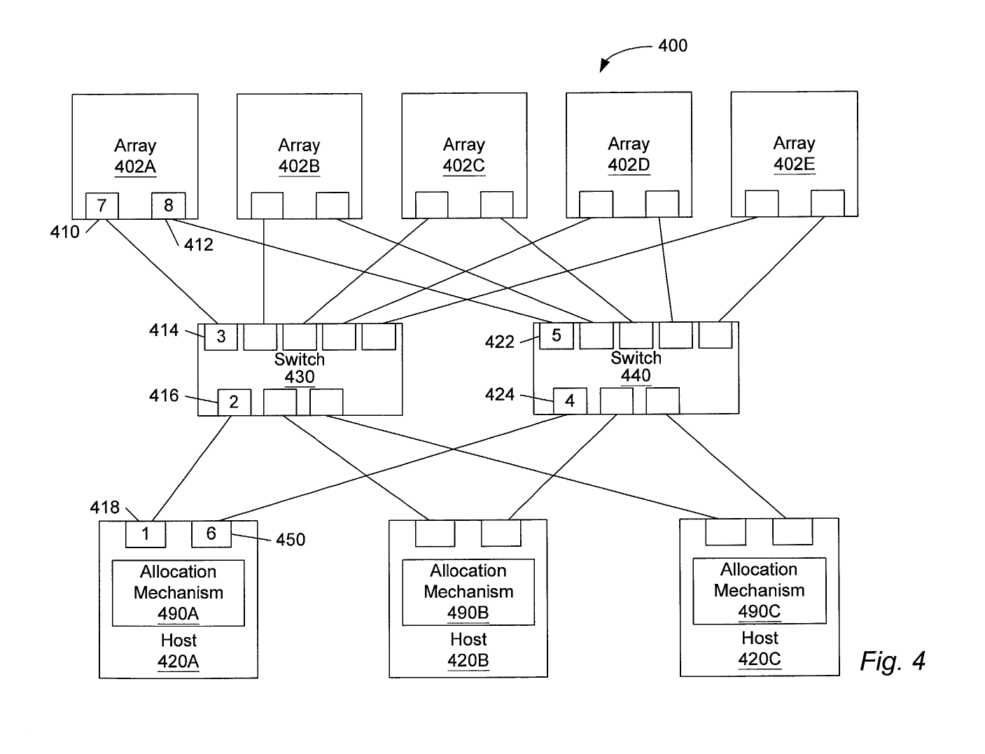

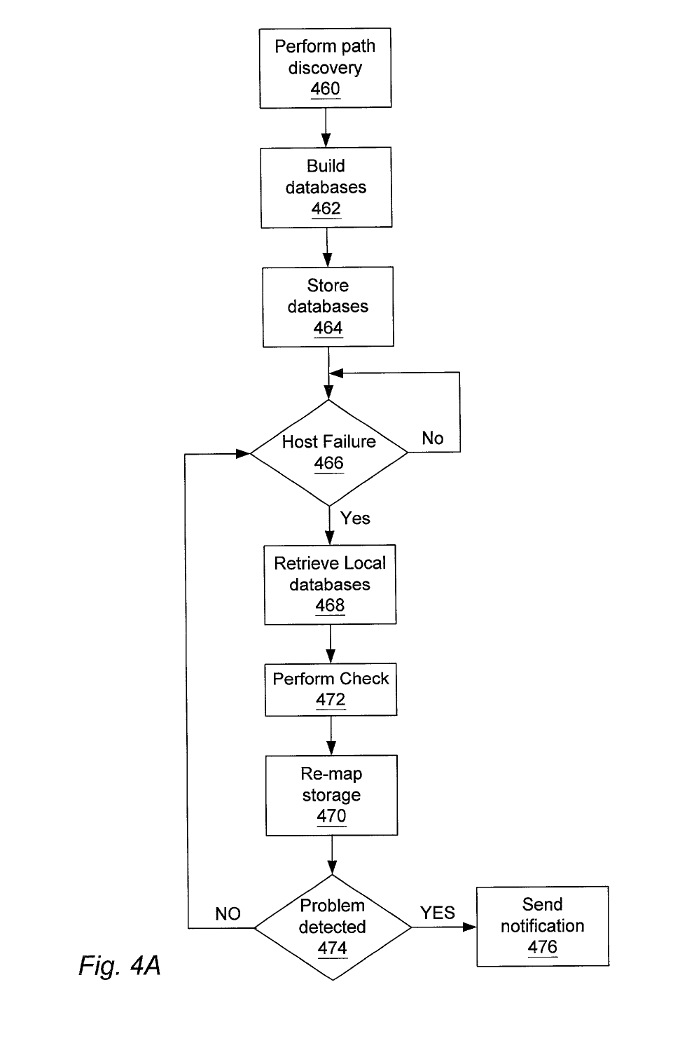

FIG. 4 is a diagram illustrating an exemplary embodiment of a SAN 400. SAN 400 includes host 420A, host 420B and host 420C, each of which includes an allocation mechanism 490A-490C. Elements referred to herein with a particular reference number followed by a letter will be collectively referred to by the reference number alone. For example, hosts 420A-420C will be collectively referred to as hosts 420. SAN 400 also includes storage arrays 402A-402E. Switches 430 and 440 are utilized to couple hosts 420 to arrays 402. Host 420A includes interface ports 418 and 450 numbered 1 and 6, respectively. Switch 430 includes ports 414 and 416 numbered 3 and 2, respectively. Switch 440 includes ports 422 and 424 numbered 5 and 4 respectively. Finally, array 402A includes ports 410 and 412 numbered 7 and 8, respectively.

In the embodiment of FIG. 4, the allocation mechanism 490A of host 420A is configured to assign one or more storage arrays 402 to itself 420A. In one embodiment, the operating system of host 420A includes a storage “mapping” program or utility which is configured to map a storage array to the host and the allocation mechanism 490 comprises a processing unit executing program code. Other embodiments of allocation mechanism 490 may include special circuitry and/or a combination of special circuitry and program code. This mapping utility may be native to the operating system itself, may be additional program instruction code added to the operating system, may be application type program code, or any other suitable form of executable program code. A storage array that is mapped to a host is read/write accessible to that host. A storage array that is not mapped to a host is not accessible by, or visible to, that host. The storage mapping program includes a path discovery operation which is configured to automatically identify all storage arrays on the SAN. In one embodiment, the path discovery operation of the mapping program includes querying a name server on a switch to determine if there has been a notification or registration, such as a Request State Change Notification (RSCN), for a disk doing a login. If such a notification or registration is detected, the mapping program is configured to perform queries via the port on the switch corresponding to the notification in order to determine all disks on that particular path.

In the exemplary embodiment shown in FIG. 4, upon executing the native mapping program within host 420A, the mapping program may be configured to perform the above described path discovery operation via each of ports 418 and 450. Performing the path discovery operation via port 418 includes querying switch 430 and performing the path discovery operation via port 450 includes querying switch 440. Querying switch 430 for notifications as described above reveals a notification or registration from each of arrays 402A-402E. Performing queries via each of the ports on switch 430 corresponding to the received notifications allows identification of each of arrays 402A-402E and a path from host 420A to each of the arrays 402A-402E. Similarly, queries to switch 440 via host port 450 results in discovery of paths from host 402A via port 450 to each of arrays 402A-402E. In addition the above, switch ports which are connected to other switches may be identified and appropriate queries may be formed which traverse a number of switches. In general, upon executing the mapping program on a host, a user may be presented a list of all available storage arrays on the SAN reachable from that host. The user may then select one or more of the presented arrays 402 to be mapped to the host.

For example, in the exemplary embodiment of FIG. 4, array 402A is to be mapped to host 420A. A user executes the mapping program on host 402A which presents a list of storage arrays 402. The user then selects array 402A for mapping to host 420A. While the mapping program may be configured to build a single path between array 402A and host 420A, in one embodiment the mapping program is configured to build at least two paths of communication between host 420A and array 402A. By building more than one path between the storage and host, a greater probability of communication between the two is attained in the event a particular path is busy or has failed. In one embodiment, the two paths of communication between host 420A and array 402A are mapped into the kernel of the operating system of host 420A by maintaining an indication of the mapped array 402A and the corresponding paths in the system memory of host 420A.

In the example shown, host 420A is coupled to switch 430 via ports 418 and 416, and host 420A is coupled to switch 440 via ports 450 and 424. Switch 430 is coupled to array 402A via ports 414 and 410, and switch 440 is coupled array 402A via ports 422 and 412. Utilizing the mapping program a user may select ports 418 and 450 on host 420A for communication between the host 420A and the storage array 402A. The mapping program then probes each path coupled to ports 418 and 450, respectively. Numerous probing techniques are well known in the art, including packet based and TCP based approaches. Each switch 430 and 440 is then queried as to which ports on the respective switches communication must pass through to reach storage array 402A. Switches 430 and 440 respond to the query with the required information, in this case ports 414 and 422 are coupled to storage array 402A. Upon completion of the probes, the mapping program has identified two paths to array 402A from host 420A.

To further enhance reliability, in one embodiment the mapping program is configured to build two databases corresponding to the two communication paths which are created and store these databases on the mapped storage and the host. These databases serve to describe the paths which have been built between the host and storage. In one embodiment, a syntax for describing these paths may include steps in the path separated by a colon as follows:

node_name:hba1_wwn:hba2_wwn:switch1_wwn:switch2_wwn:spe1:spe2:ap1_wwn:ap2_wwn

In the exemplary database entry shown above, the names and symbols have the following meanings:

node_name→name of host which is mapped to storage;

hba1_wwn→(World Wide Name) WWN of the port on the (Host Bus Adapter) HBA that resides on node_name. A WWN is an identifier for a device on a Fibre Channel network. The Institute of Electrical and Electronics Engineers (IEEE) assigns blocks of WWNs to manufacturers so they can build Fibre Channel devices with unique WWNs.

hba2_wwn_WWN of the port on the HBA that resides on node_name

switch1_wwn_WWN of switch1. Every switch has a unique WWN, it is possible that there could be more then 2 switches out in the SAN. Therefore, there would be more than 2 switch_wwn entries in this database.

switch2_wwn→WWN of switch2.

spe1→The exit port number on switch1 which ultimately leads to the storage array.

spe2→The exit port number on switch2.

ap1_wwn→The port on the storage array for path 1.

ap2_wwn→The port on the storage array for path 2.

It is to be understood that the above syntax is intended to be exemplary only. Numerous alternatives for database entries and configuration are possible and are contemplated.

As mentioned above, the path databases may be stored locally within the host and within the mapped storage array itself. A mapped host may then be configured to access the database when needed. For example, if a mapped host is rebooted, rather than re-invoking the mapping program the host may be configured to access the locally stored database in order to recover all communication paths which were previously built and re-map them to the operating system kernel. Advantageously, storage may be re-mapped to hosts in an automated fashion without the intervention of a system administrator utilizing a mapping program.

In addition to recovering the communication paths, a host may also be configured to perform a check on the recovered database and paths to ensure their integrity. For example, upon recovering a database from local storage, a host may perform a checksum or other integrity check on the recovered data to ensure it has not been corrupted. Further, upon recovering and re-mapping the paths, the host may attempt to read from the mapped storage via both paths. In one embodiment, the host may attempt to read the serial number of a drive in an array which has been allocated to that host. If the integrity check, or one or both of the reads fails, an email or other notification may be conveyed to a system administrator or other person indicating a problem. If both reads are successful and both paths are active, the databases stored on the arrays may be compared to those stored locally on the host to further ensure there has been no corruption. If the comparison fails, an email or other notification may be conveyed to a system administrator or other person as above.

FIG. 4A illustrates one embodiment of a method of the storage allocation mechanism described above. Upon executing a native mapping program on a host, path discovery is performed (block 460) which identifies storage on the SAN reachable from the host. Upon identifying the available storage, a user may select an identified storage for mapping to the host. Upon selecting storage to map, databases are built (block 462) which describe the paths from the host to the storage. The databases are then stored on the host and the mapped storage (block 464). If a failure of the host is detected (block 466) which causes a loss of knowledge about the mapped storage, the local databases are retrieved (block 468). Utilizing the information in the local databases, the storage may be re-mapped (block 470), which may include re-mounting and any other actions necessary to restore read/write access to the storage. Subsequent to re-mapping the storage, an integrity check may be performed (block 472) which includes comparing the locally stored databases to the corresponding databases stored on the mapped storage. If a problem is detected by the integrity check (block 474), a notification is sent to the user, system administrator, or other interested party (block 476). If no problem is detected (block 474), flow returns to block 466. Advantageously, the mapping and recovery of mapped storage in a computer network may be enhanced.

### Storage Re-Allocation

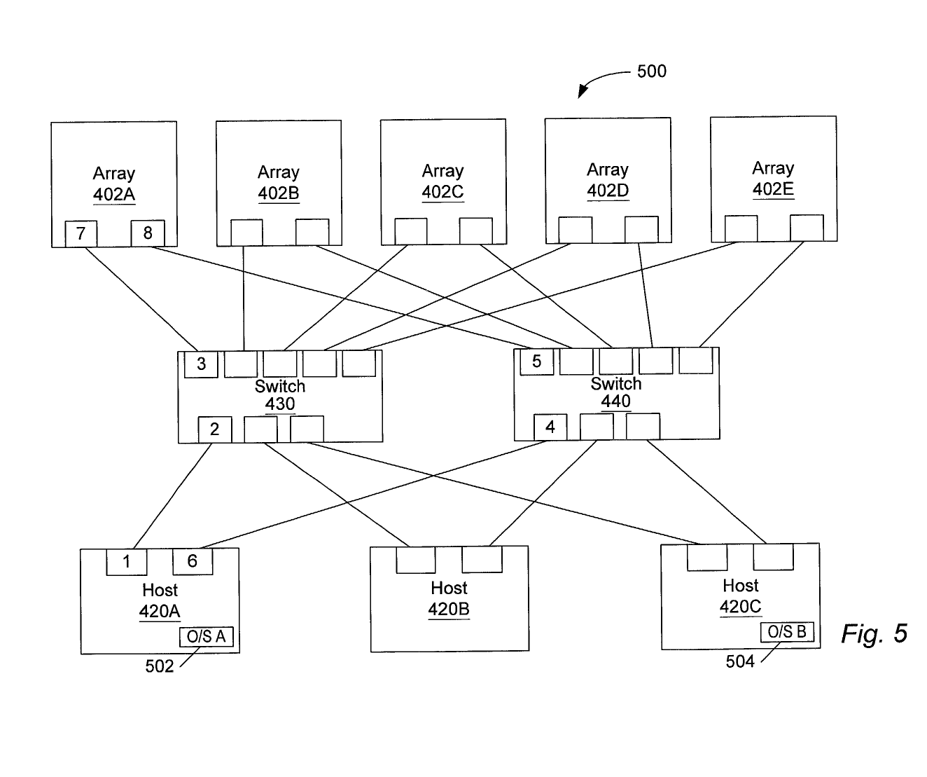

In the administration of SANs, it is desirable to have the ability to safely re-allocate storage from one host to another. Whereas an initial storage allocation may be performed at system startup, it may be desired to re-allocate storage from one host to another. In some cases, the ease with which storage may be re-allocated from one host to another makes the possibility of accidental data loss a significant threat. The following scenario illustrates one of many ways in which a problem may occur. FIG. 5 is a diagram of a SAN 500 including storage arrays 402, hosts 420, and switches 430 and 440. Assume that host 420A utilizes an operating system A 502 which is incompatible with an operating system B 504 on host 420C. Each of operating systems A 502 and B 504 utilize file systems which may not read or write to the other.

In one scenario, performance engineers operating from host 420A are running benchmark tests against the logical unit numbers (LUNs) on storage array 402A. As used herein, a LUN is a logical representation of physical storage which may, for example, represent a disk drive, a number of disk drives, or a partition on a disk drive, depending on the configuration. During the time the performance engineers are running their tests, a system administrator operating from host 420B utilizing switch management software accidentally re-allocates the storage on array 402A from host 420A to host 420C. Host 420C may then proceed to reformat the newly assigned storage on array 402A to a format compatible with its file system. In the case where both hosts utilize the same file system, it may not be necessary to reformat. Subsequently, host 420A attempts to access the storage on array 402A. However, because the storage has been re-allocated to host 420C, I/O errors will occur and the host 420A may crash. Further, on reboot of host 420A, the operating system 502 will discover it cannot mount the file system on array 402A that it had previously mounted and further errors may occur. Consequently, any systems dependent on host 420A having access to the storage on array 402A that was re-allocated will be severely impacted.

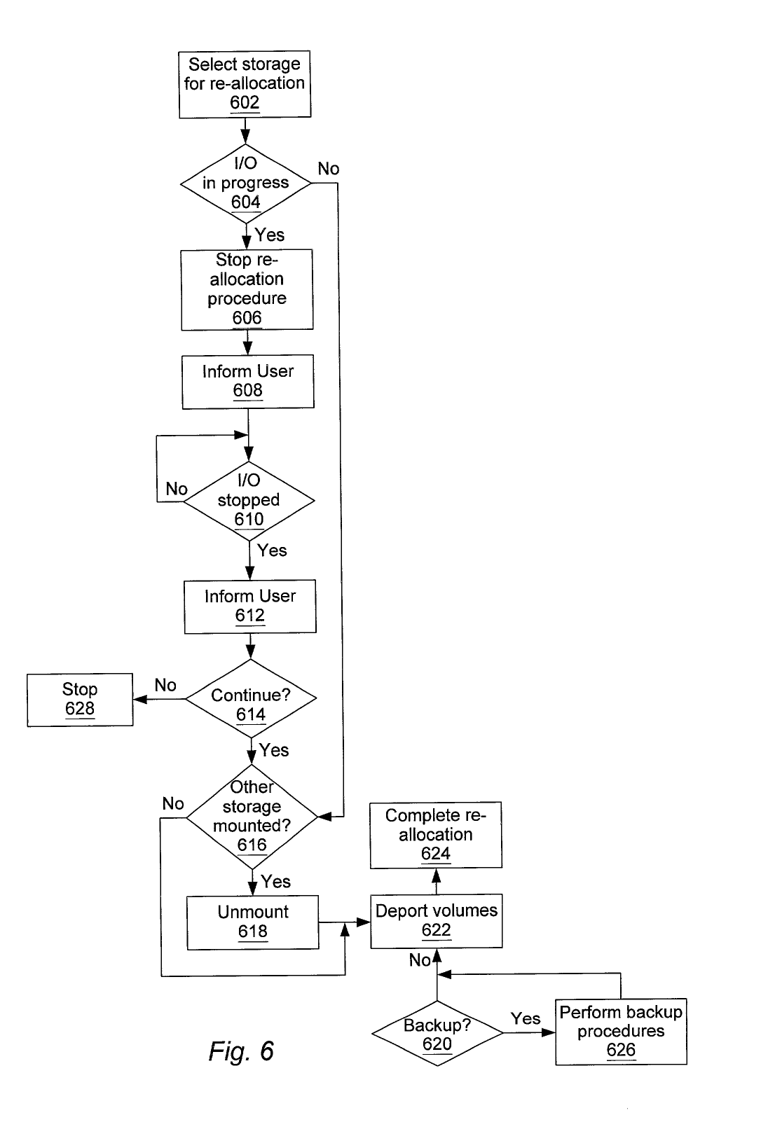

In order to protect against data loss, data corruption and scenarios such as that above, a new method and mechanism of re-allocating storage is described. The method ensures that storage is re-allocated in a graceful manner, without the harmful effects described above. FIG. 6 is a diagram showing one embodiment of a method for safely re-allocating storage from a first host to a second host. Initially, a system administrator or other user working from a host which is configured to perform the re-allocation procedure selects a particular storage for re-allocation (block 602) from the first host to the second host. In one embodiment, a re-allocation procedure for a particular storage may be initiated from any host which is currently mapped to that storage. Upon detecting that the particular storage is to be re-allocated, the host performing the re-allocation determines whether there is currently any I/O in progress corresponding to that storage (decision block 604). In one embodiment, in order to determine whether there is any I/O in progress to the storage the re-allocation mechanism may perform one or more system calls to determine if any processes are reading or writing to that particular storage. If no I/O is in progress, a determination is made as to whether any other hosts are currently mounted on the storage which is to be re-allocated (decision block 616).

On the other hand, if there is I/O in progress (decision block 604), the re-allocation procedure is stopped (block 606) and the user is informed of the I/O which is in progress (block 608). In one embodiment, in response to detecting the I/O the user may be given the option of stopping the re-allocation procedure or waiting for completion of the I/O. Upon detecting completion of the I/O (decision block 610), the user is informed of the completion (block 612) and the user is given the opportunity to continue with the re-allocation procedure (decision block 614). If the user chooses not to continue (decision block 614), the procedure is stopped (block 628). If the user chooses to continue (decision block 614), a determination is made as to whether any other hosts are currently mounted on the storage which is to be re-allocated (decision block 616). If no other hosts are mounted on the storage, flow continues to decision block 620. If other hosts are mounted on the storage, the other hosts are unmounted (block 618).

Those skilled in the art will recognize that operating systems and related software typically provide a number of utilities for ascertaining the state various aspects of a system such as I/O information and mounted file systems. Exemplary utilities available in the UNIX operating system include iostat and fuser. (“UNIX” is a registered trademark of UNIX System Laboratories, Inc. of Delaware). Many other utilities, and utilities available in other operating systems, are possible and are contemplated.

In one embodiment, in addition to unmounting the other hosts from the storage being re-allocated, each host which has been unmounted may also be configured so that it will not attempt to remount the unmounted file systems on reboot. Numerous methods for accomplishing this are available. One exemplary possibility for accomplishing this is to comment out the corresponding mount commands in a host's table of file systems which are mounted at boot. Examples of such tables are included in the /etc/vfstab file, /etc/fstab file, or /etc/filesystems file of various operating systems. Other techniques are possible and are contemplated as well. Further, during the unmount process, the type of file system in use may be detected and any further steps required to decouple the file system from the storage may be automatically performed. Subsequent to unmounting (block 618), the user is given the opportunity to backup the storage (decision block 620). If the user chooses to perform a backup, a list of known backup tools may be presented to the user and a backup may be performed (block 626). Subsequent to the optional backup, any existing logical units corresponding to the storage being re-allocated are de-coupled from the host and/or storage (block 622) and re-allocation is safely completed (block 624).

Various embodiments may further include receiving, sending or storing instructions and/or data implemented in accordance with the foregoing description upon a carrier medium. Generally speaking, a carrier medium may include storage media or memory media such as magnetic or optical media, e.g., disk or CD-ROM, volatile or non-volatile media such as RAM (e.g. SDRAM, RDRAM, SRAM, etc.), ROM, etc. as well as transmission media or signals such as electrical, electromagnetic, or digital signals, conveyed via a communication medium such as network and/or a wireless link. Numerous variations and modifications will become apparent to those skilled in the art once the above disclosure is fully appreciated. It is intended that the following claims be interpreted to embrace all such variations and modifications.

What is claimed is:

1. A method of allocating storage to a host in a computer network, said method comprising:
performing path discovery;
identifying storage coupled to said computer network;
mapping said storage to said host;
building a storage path database; and
storing said database.

2. The method of claim 1, wherein said path discovery comprises:
querying a switch coupled to said host;
detecting an indication that said storage is coupled to said switch via a first port; and
performing a query via said first port.

3. The method of claim 1, wherein said database is stored within said host.

4. The method of claim 3, further comprising storing said database on said storage.

5. The method of claim 3, further comprising:
detecting a failure of said host;
retrieving said stored database, in response to detecting said failure; and
utilizing said database to re-map said storage to said host.

6. The method of claim 5, further comprising:
performing a check on said database subsequent to said retrieving, wherein said check comprises determining whether said database is valid; and
conveying a notification indicating said database is invalid, in response to determining said database is not valid.

7. The method of claim 5, further comprising:
performing a check on said database subsequent to said retrieving, wherein said check comprises attempting to access said storage; and
conveying a notification of a failure to access said storage, in response to detecting said storage is inaccessible.

8. A computer network comprising:
a network interconnect, wherein said interconnect includes a switching mechanism;
a first storage device coupled to said interconnect; and
a first host coupled to said interconnect, wherein said first host is configured to perform path discovery, identify said first storage coupled to said computer network, map said first storage to said host, build a storage path database, and store said database.

9. The computer network of claim 8, wherein said path discovery comprises:
querying said switching mechanism;
detecting an indication that said first storage is coupled to said switching mechanism via a first port of said switching mechanism; and
performing a query via said first port.

10. The computer network of claim 8, wherein said database is stored locally within said host.

11. The computer network of claim 10, further comprising storing said database on said first storage device.

12. The computer network of claim 10, wherein said host is further configured to:
detect a failure of said host;
retrieve said stored database, in response to detecting said failure; and
utilize said database to re-map said first storage to said host.

13. The computer network of claim 12, wherein said host is further configured to:
perform a check on said database subsequent to retrieving said database, wherein said check comprises determining whether said database valid; and
convey a notification indicating said database is invalid, in response to said determining said database is not valid.

14. A host comprising:
a first port configured to be coupled to a computer network; and
an allocation mechanism, wherein said mechanism is configured to perform path discovery, identify a first storage coupled to said computer network, map said first storage to said host, build a storage path database, and store said database.

15. The host of claim 14, wherein said path discovery comprises:
querying a switch coupled to said first port;
detecting an indication that said first storage is coupled to said switch via a port of said switch; and
performing a query via said port of said switch.

16. The host of claim 14, further comprising a local storage device, wherein said database is stored within said local storage device.

17. The host of claim 16, wherein said allocation mechanism is further configured to store said database on said first storage.

18. The host of claim 16, wherein said allocation mechanism is further configured to:
detect a failure of said host;
retrieve said stored database from said local storage device in response to detecting said failure; and
utilize said database to re-map said first storage to said host.

19. The host of claim 18, wherein said allocation mechanism is further configured to:
perform a check on said database subsequent to retrieving said database, wherein said check comprises determining whether said database is valid; and
convey a notification indicating said database is invalid, in response to determining said database is not valid.

20. The host of claim 14, wherein said allocation mechanism comprises a processing unit executing program instructions.

21. A carrier medium comprising program instructions, wherein said program instructions are executable to:
perform path discovery;
identify storage coupled to a computer network;
map said storage to a host;
build a storage path database; and
store said database.

22. The carrier medium of claim 21, wherein said program instructions are further executable to:
query a switch coupled to said host;
detect an indication that said storage is coupled to said switch via a first port; and
perform a query via said first port.

23. The carrier medium of claim 21, wherein said database is stored within said host.

24. The carrier medium of claim 23, wherein said program instructions are further executable to store said database on said storage.

25. The carrier medium of claim 23, wherein said program instructions are further executable to:
detect a failure of said host;
retrieve said stored database, in response to detecting said failure; and
utilize said database to re-map said storage to said host.

26. The carrier medium of claim 25, wherein said program instructions are further executable to:
perform a check on said database subsequent to retrieving said stored database, wherein said check comprises determining whether said database is valid; and
convey a notification indicating said database is invalid, in response to determining said database is not valid.

27. The carrier medium of claim 25, wherein said program instructions are further executable to:
perform a check on said database subsequent to retrieving said stored database, wherein said check comprises attempting to access said storage; and
conveying a notification of a failure to access said storage, in response to detecting said storage is inaccessible.

28. The carrier medium of claim 21, wherein said program instructions are native to an operating system executing within a host.

29. A method of identifying and allocating storage to a host in a computer network, said method comprising:
identifying storage coupled to said computer network;
identifying a path between said identified storage and said host;
mapping said identified storage to said host;
building a storage path database;
storing said database; and
automatically initiating an attempt to re-map said storage to said host, wherein said automatic attempt comprises detecting a failure of said host, retrieving said stored database, and utilizing said database to re-map said storage to said host.

30. A computer network comprising:
a network interconnect;
a first storage coupled to said interconnect; and
a first host coupled to said interconnect, wherein said first host is configured to:
identify said first storage;
identify a path between said first storage and said host;
map said first storage to said host;
build a storage path database;
store said database; and
automatically initiate an attempt to re-map said storage to said host,
wherein said host is configured to detect a failure of said host,
retrieve said stored database in response to detecting said failure,
and utilize said database to re-map said first storage to said host.

31. A host comprising:
a first port configured to be coupled to a computer network; and
an allocation mechanism, wherein said mechanism is configured to:
identify storage coupled to said computer network;
identify a path between said storage and said host;
map said storage to said host;
build a storage path database;
store said database; and
automatically initiate an attempt to re-map said storage to said host,
wherein said host is configured to detect a failure of said host,
retrieve said stored database in response to detecting said failure,
and utilize said database to re-map said first storage to said host.

32. A carrier medium comprising program instructions, wherein said program instructions are executable to:
identify storage coupled to a computer network;
identify a path between said storage and a host;
map said storage to said host;
build a storage path database;
store said database; and
automatically initiate an attempt to re-map said storage to said host, wherein in performing said attempt said instructions are executable to detect a failure of said host, retrieve said stored database in response to detecting said failure, and utilize said database to re-map said first storage to said host.
